(19) United States
(12) Patent Application Publication
(10) Pub. No.: US 2008/0220114 A1
(43) Pub. Date: Sep. 11, 2008

(54) METHOD AND APPARATUS FOR CONDITIONING PREFORMS IN AN INJECTION STRETCH BLOW MOLD MACHINE

(75) Inventors: Brian R. Lefebure, Lee's Summit, MO (US); David A. Brunson, Lee's Summit, MO (US)

Correspondence Address: HOVEY WILLIAMS LLP, 10801 Mastin Blvd., Suite 1000, Overland Park, KS, 66210, US

(73) Assignee: R & D Tool & Engineering Co., Lee's Summit, MO (US)

(21) Appl. No.: 11/682,133

(22) Filed: Mar. 5, 2007

(51) Int. Cl. B29C 49/64

(52) U.S. Cl. 425/526

(57) ABSTRACT

The conditioning station of an injection stretch blow mold machine is provided with a heater ring for each hot, soft preform presented to the station. The heater ring emits infrared light waves that are confined to the transition region of the preform between the neck and main body portions to pin-point the addition of heat to the transition region.

### TECHNICAL FIELD

The present invention relates to improvements in the conditioning of soft, hot preforms on an injection stretch blow mold machine immediately following formation of the preforms at the injection station and before the preforms are stretched and blown into bottles at the blow station. More particularly, it relates to improvements in heating a critical area of such preforms in a transition region located immediately below the threaded neck finish of the preform and the main body portion thereof.

### BACKGROUND

When making bottles from synthetic resinous material such as polyethylene terephthalate (PET) in the injection stretch blow mold process, there can be a problem in fully utilizing all of the plastic material that is in the transitional neck area of the preform that ultimately forms the neck and upper shoulder region of the blown bottle. This area of the preform cools down slightly compared to the remaining body portion of the preform due to heat loss experienced because the preform is held captive in thread splits via the neck finish throughout the entire machine process until the blown bottle is ejected from the machine. The thread splits are at room temperature throughout this process and thus operate as heat sinks to draw heat from the preform not only in the area of the threaded neck, but also in a transition portion extending for a distance below the bottom face of the thread split.

The loss of heat in this transition region of the preform results in the inability of the plastic material to stretch and move properly during the stretch blow cycle. The result is an unsightly, heavy ring of material in the transition area of the blown bottle that sometimes creates an inward bulge of material at the base of the neck finish commonly referred to as a “choke.” Furthermore, this heavy band of material constitutes excess weight in the blown bottle that serves no useful purpose.

It is known in the art to add heat to the preform using a stack of donut-shaped “heat pots” at the conditioning station that receive and surround the body of the preform below the thread splits. It is also common to add heat by inserting a heat core into the preform from above the thread splits. However, these techniques are unable to pinpoint heat to the transition region of the preform and thus fail to address the transition region problem.

### BRIEF DESCRIPTION OF THE DRAWINGS

FIG. 1 is a fragmentary, front elevational view of the conditioning station of an injection stretch blow mold machine incorporating a conditioning unit in accordance with the principles of the present invention, the upper and lower machine castings being shown in cross-section for clarity, and the lower machine casting and conditioning unit being shown in a lowered condition relative to the upper casting;

FIG. 2 is a fragmentary, front elevational view of the conditioning station of FIG. 1, but showing the lower machine casting and conditioning unit in a fully raised position;

FIG. 3 is an enlarged, fragmentary cross-sectional view of the conditioning station taken substantially along line 3-3 of FIG. 2;

FIG. 4 is a right, front isometric view of the conditioning unit;

FIG. 5 is a fragmentary, left rear exploded view of the conditioning unit;

FIG. 6 is an enlarged, fragmentary cross-sectional view of the conditioning unit in the vicinity of the transition region of the preform;

FIG. 7 is a schematic illustration of the choke problem in a bottle blown from a conventional preform having a constant thickness transition region using conventional conditioning techniques;

FIG. 8 is a schematic illustration of a bottle blown from a conventional preform having a constant thickness transition region using conditioning techniques in accordance with the present invention;

FIG. 9 is a schematic illustration of a bottle blown from a preform having a tapering transition region using conditioning techniques in accordance with the present invention; and

FIG. 10 is an enlarged, fragmentary plan view of the heater ring of one of the heating chambers of the conditioning unit, portions of the tubular housing of the ring being broken away to reveal internal details.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

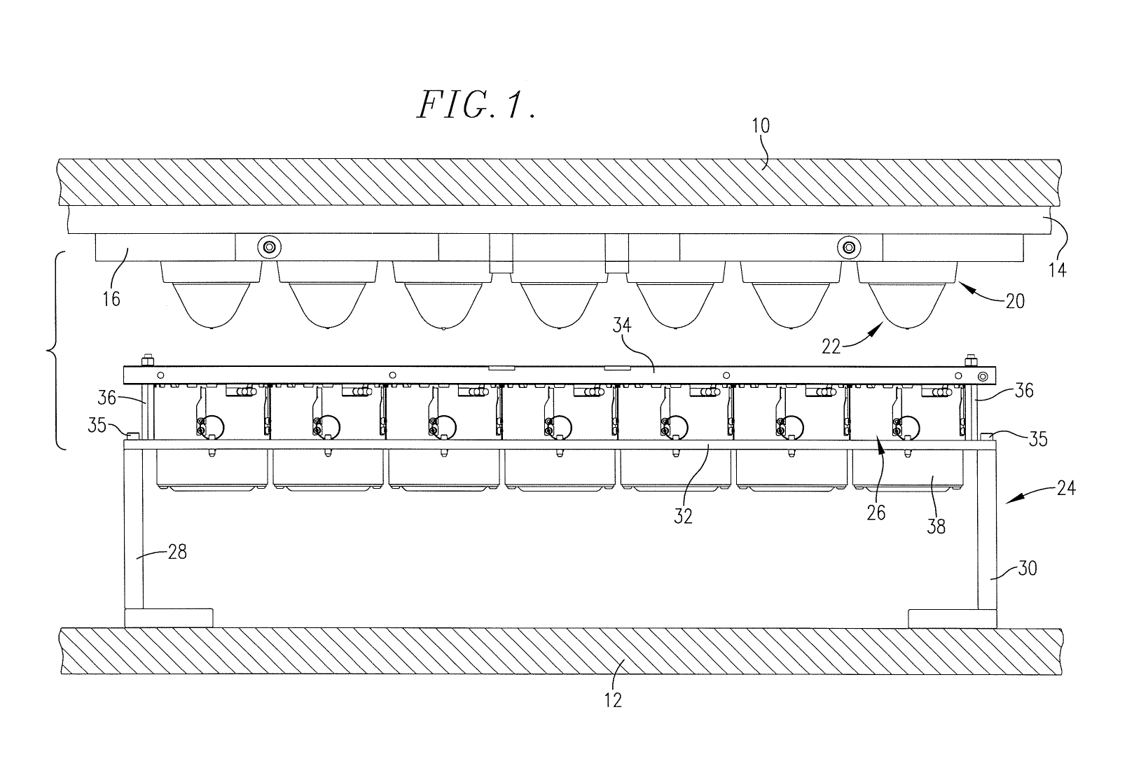

Referring initially to FIGS. 1, 2 and 3, portions of an injection stretch blow mold machine and components at the conditioning station of such machine are illustrated. The machine components include an upper machine casting 10, a lower machine casting 12, a rotation plate 14 that rotates relative to upper machine casting 10 so as to carry the preforms between injection, conditioning, stretch blow and ejection stations, and a pair of slide plates 16 and 18 that are supported by rotation plate 14. Slide plates 16 are movable toward and away from one another by means not shown and serve to support one or more thread splits 20, each of which comprises a pair of thread split halves 20a and 20b.

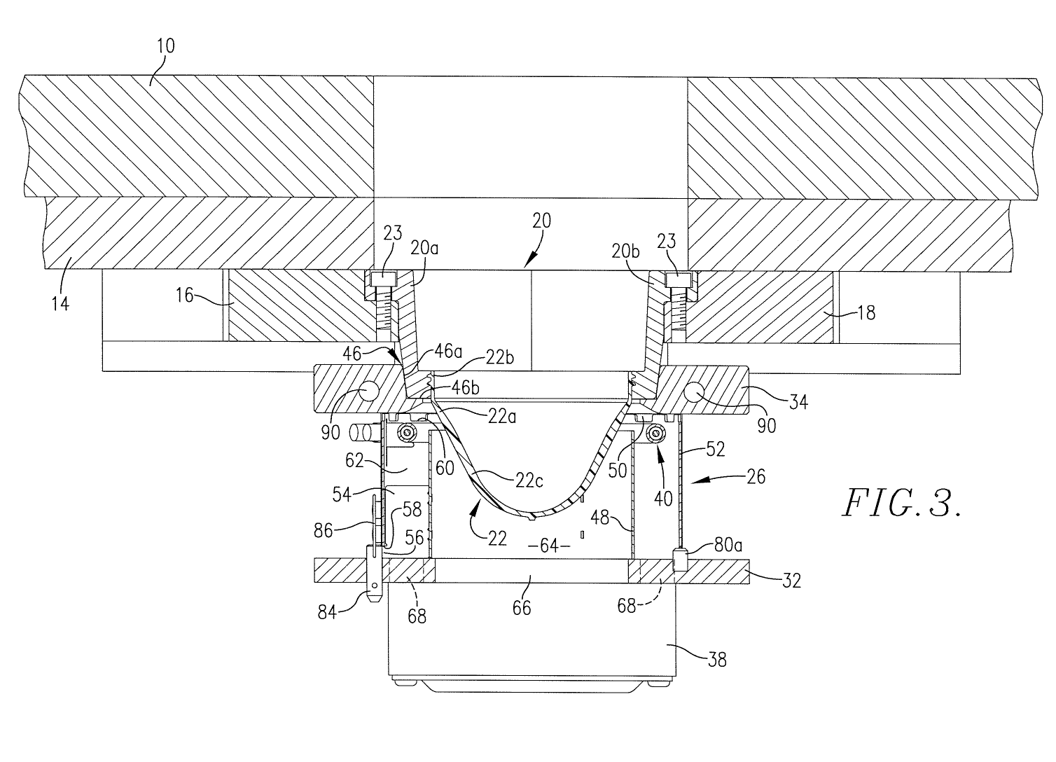

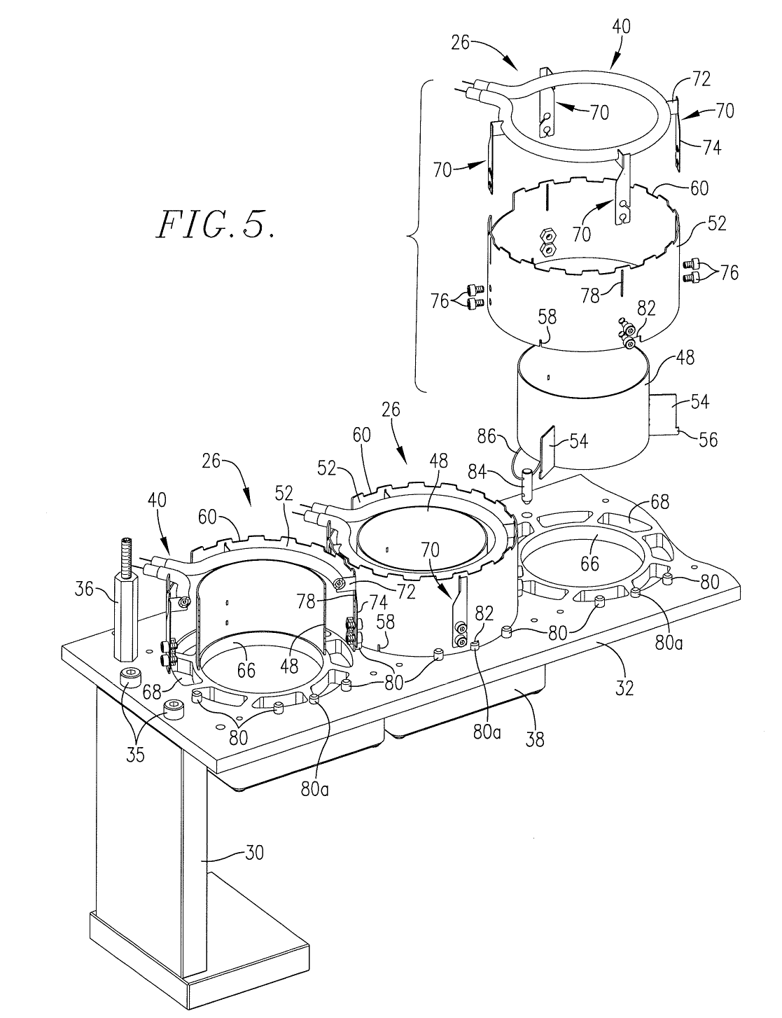

Thread splits 20 comprise part of the tooling added to the machine, and there may be any number of such thread splits depending upon the number of mold cavities in the tooling. As illustrated in FIG. 3, each thread split half 20a, 20b is fastened to its slide plate 16 or 18 by a bolt 23. As well understood by those skilled in the art, thread splits 20 are used to carry hot, soft preforms from the injection station to other stations of the machine and are opened at the ejection station by movement of slide plates 16, 18 away from one another so as to release the blown bottle. In FIG. 1, the lower casting machine 12 is retracted with respect to upper machine casting 10 so as to reveal a set of preforms 22 held by the thread splits 20. Although the preforms 22 are illustrated in the drawings (FIGS. 3 and 6) as having a tapering transition region 22a between the thinner neck portion 22b and the thicker main body portion 22c, such showing is for exemplary purposes only, as in many instances preforms having a generally constant thickness transition region will advantageously be conditioned using the present invention.

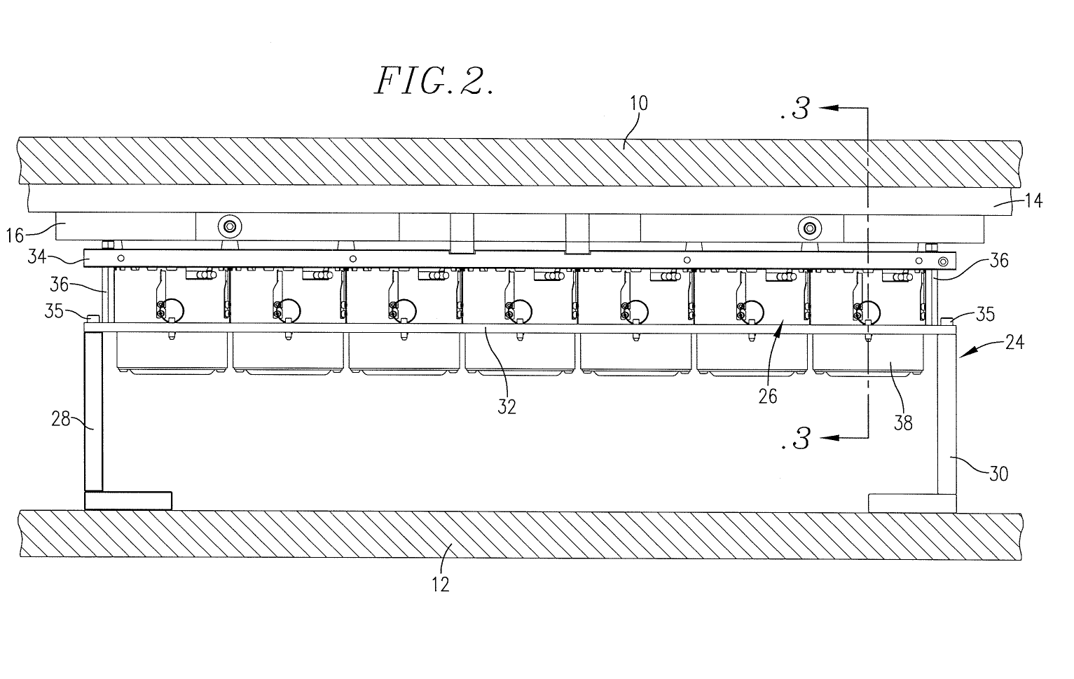

Mounted on the lower machine casting 12 and moveable therewith in a vertical direction is a conditioning unit broadly denoted by the numeral 24. Broadly speaking, conditioning unit 24 includes a plurality of heating chambers 26 corresponding in number with, and vertically aligned with, the overhead thread splits 20. In the illustrated embodiment, seven heating chambers and seven sets of thread splits 20 are illustrated, although that number can obviously vary. Each heating chamber 26 is adapted to receive and condition a corresponding one of the preforms 22 when lower machine casting 12 is elevated to its fully raised position as illustrated in FIG. 2.

Conditioning unit 24 also includes a pair of upwardly projecting stand offs 28 and 30 that are secured to lower machine casting 12 by means not shown for up and down movement therewith. In addition, conditioning unit 24 also includes a lower, horizontally extending plate 32 secured by bolts 35 to the upper ends of standoffs 28 and 30, and an upper horizontally extending plate 34 spaced above lower plate 32, and a plurality of upright spacer bolt assemblies 36 that maintain upper plate 34 secured to lower plate 32 in a fixed, vertically spaced relationship therewith. Upper plate 34, lower plate 32, and standoffs 28, 30 thus comprise a unitary structure wherein all parts move together with lower machine casting 12. Conditioning unit 24 further includes apparatus for directing cooling streams of air through the heating chambers 26. In one preferred form of the invention such apparatus comprises a series of seven electrically powered fans 38 secured to the bottom of lower support plate 32 in vertical registration with corresponding ones of the heating chambers 26, although other means such as compressed air could be used.

Each heating chamber 26 includes as a primary component an electrically energized heater ring 40 that is capable when energized of emitting light waves having a wave length that falls within the infrared region of the light spectrum. In a preferred embodiment, each heater ring 40 comprises a clear quartz glass tube 42 formed into as near of a circular configuration as possible, resulting in an omega shape which is thus generally circular. The quartz tube 42 houses a helically coiled tungsten heating element 44 and is filled with a suitable halogen gas. The emitted radiation of heating element 44 preferably has a wave length in the range of 1,000-2,200 nanometers, with a most preferred value of 1,200 nanometers. One suitable such heater ring is available from Ceramicx Ireland Ltd. of Gortnagrough, Ballydehob, Cork, Ireland as a “Quartz Tungsten Infrared Heating Lamp”, having a ceramic reflective coating on the outside half of the tube and being rated at approximately 1850 watts at 230 volts with a 6000 hour life minimum.

Each heater ring 40 is disposed near the top of heating chamber 26 just below upper plate 34. Heater ring 40 is concentrically aligned with an overhead hole 46 in top plate 34 so as to be in a position to encircle (at least substantially) a preform 22 received by heating chamber 26 when conditioning unit 24 is in its fully raised position. It will be noted that hole 46 has a chamfered sidewall 46a matching the taper of thread splits 20 so as to help center heating chamber 26 with respect to preform 22 when conditioning unit 24 is fully raised. A lower lip 46b engages the bottom edge of thread split 20 when conditioning unit 24 is in its fully raised position.

Each heating chamber 26 also includes an upstanding, preferably cylindrical inner shield 48 that sits on lower plate 32 in coaxial registration with heater ring 40 and hole 46 in top plate 34. As noted particularly in FIGS. 3 and 6, inner shield 48 is of such a height that its upper edge is spaced a short distance below upper plate 34, thereby defining a gap or “window” 50 between the upper edge of inner shield 48 and top plate 34 (as well as the bottom surface of thread splits 20). This window 50 is of annular configuration in a most preferred embodiment and is so located that radiation in the form of infrared light waves emitted from heater ring 40 can pass through window 50 and be absorbed by transition area 22a of preform 22.

It will be noted that the body portion 22c of preform 22 projects downwardly into the interior of shield 48 and is protected by shield 48 against exposure to infrared light waves from heater ring 40. In a most preferred embodiment, inner shield 48 is constructed from 300 series stainless steel.

Each heating chamber 26 further includes a cylindrical, upright, outer shield 52, preferably constructed of 300 series stainless steel as in the case of inner shield 48. Outer shield 52 is spaced radially outwardly from inner shield 48 in concentric relationship therewith and is maintained in that relationship by a plurality of spacer fins 54 that project radially outwardly from inner shield 48. Tabs 56 at the lower corners of fins 54 fit into corresponding notches 58 in outer shield 52 to maintain a fixed relationship between inner and outer shields 48, 52 respectively.

Outer shield 52 is taller than inner shield 48 and is of such a height that it extends the full vertical distance between lower plate 32 and upper plate 34. The upper edge extremity of each outer shield 52 is serrated to provide a plurality of notches 60 that serve as cooling air exhaust ports as hereinafter explained in more detail.

The inner and outer shields 48, 52 respectively define an annular space 62 therebetween. The inner shield 48 defines a receiving space 64 for preform 22. Both of these spaces are adapted to receive cooling air flow from a corresponding fan 38 attached to lower plate 32 therebeneath. A large hole 66 in bottom plate 32 beneath each inner shield 48 and in registration with receiving space 64 allows the passage of cooling air from fan 38 to the receiving space 64 and outwardly through the upper end of interior shield 52. The air thereupon exhausts from the heating chamber 26 via notches 60. Similarly, a series of circumferentially spaced, generally trapezoidal holes 68 in bottom plate 32 just outboard of large hole 66 are located in vertical registration with annular space 62 to admit air from fan 38 to such space for passage therethrough and out of the heating chamber 26 via notches 60 at the upper end thereof.

Heater ring 40 is supported within annular space 62 adjacent the top end thereof by four supporting brackets 70 spaced about the circumference of heater ring 40. As illustrated perhaps best in FIG. 5, each bracket 70 is generally inversely L-shaped, having an upper inwardly projecting leg 72 that engageably supports ring 40 and an upright leg 74 that is secured to the exterior of outer shield 52 by bolts 76 or the like. Legs 72 of brackets 70 project through slots 78 in outer shield 52 and extend for a distance radially inwardly therefrom to engage and support the heater ring 40.

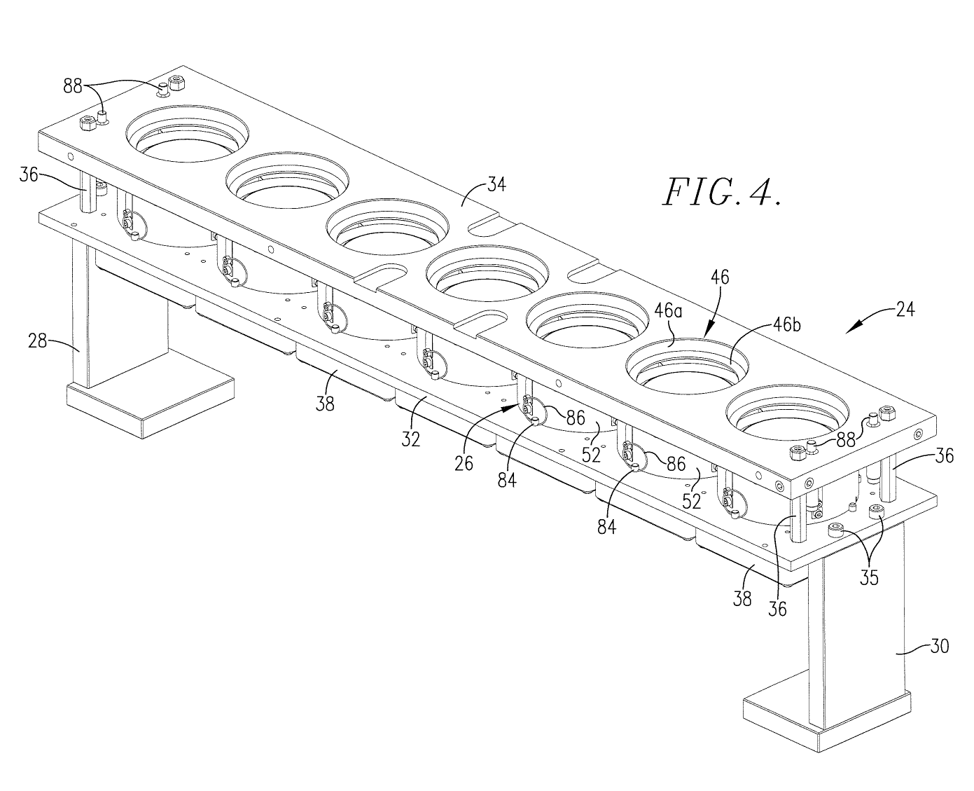

Each heating chamber 26 is properly located on bottom plate 32 through the use of a series of upwardly projecting dowels 80 around the exterior rear half of outer shield 52. Dowels 80 are disposed slightly outboard of holes 68 in lower plate 32. One of the dowels 80a is disposed to be received within a notch 82 in the lower edge of outer shield 52 so as to properly locate heating chamber 26 in a rotational sense. At the front of each heating chamber 26, a removable dowel pin 84 with a finger-pull ring 86 is removably received within a hole in top plate 32 for retaining the heating chamber 26 butted up against rear dowels 80. Upon removal of pin 84, the entire heating chamber 26 may be removed horizontally from between lower plate 32 and upper plate 34 for maintenance or other purposes. A plurality of spring-loaded shock absorbers 88 (FIG. 4) are provided at opposite ends of conditioning unit 24 and project slightly above top plate 34 for dampening the shock loading against conditioning unit 24 when lower machine casting 12 is moved up to its fully raised position.

### Operation

When a set of preforms is made at the injection station, the thread splits 20 are utilized as integral parts of the mold tooling so that at the completion of the injection cycle, as the mold cavities are withdrawn, the preforms are left hanging by the thread splits. At this time, the preforms are hot and soft, having a temperature above the transition temperature and in the range to properly blow the material. Rotation plate 14 is then actuated to index the bank of thread splits and preforms to the conditioning station where the preforms are initially spaced above conditioning unit 24. This is illustrated, for example, in FIG. 1. Lower machine casting 12 is thereupon moved up to its raised position as illustrated in FIG. 2, causing the preforms 22 to be inserted within the aligned heating chambers 26 of conditioning unit 24.

As illustrated in FIG. 3, when a preform 22 is received within a heating chamber 26, the transition 22a is generally aligned with window 50 while the main body portion 22c of the preform is received down within the interior shield 48. Thus, when heater ring 40 is energized, infrared radiation from the filament 44 passes through window 50 and is absorbed into the transition region 22a, causing it to heat up. At the same time, the main body portion 22c is shielded by inner shield 48 against infrared radiation from heater ring 40 to avoid adding additional heat to that area. The outer shield 52 of each heating chamber 26 protects adjacent chambers 26 from radiation and also protects other areas of the tooling. Heater ring 40 is energized for only a few seconds, whereupon it is shut off and the preforms are ready to be indexed to the blow station.

During the time that the transition region 22a is exposed to infrared light waves from heater ring 40, cooling air is passed up through inner shield 48 and the annular space 62 in such volume and at such a rate as needed to control the temperature of heater element 40 and the body 22c of preform 22. In addition, liquid coolant is continuously circulated through upper plate 34 via coolant passages 90 to also serve as a means for balancing conditions to give just the right amount of heat increase to the transition area 22a.

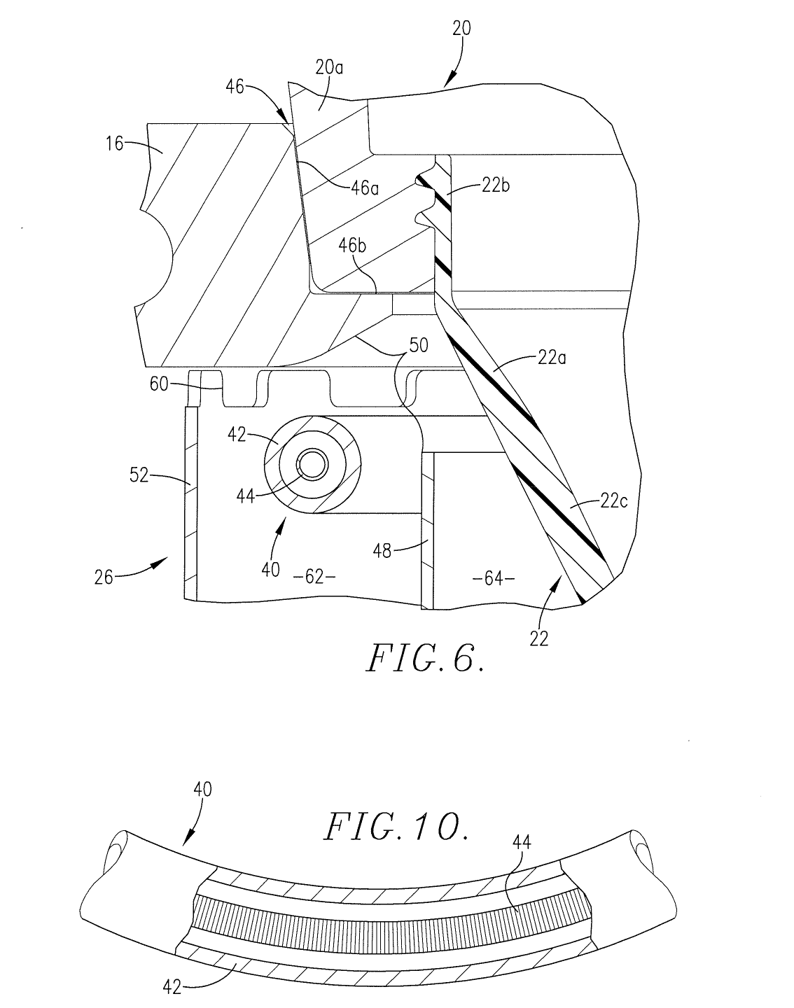

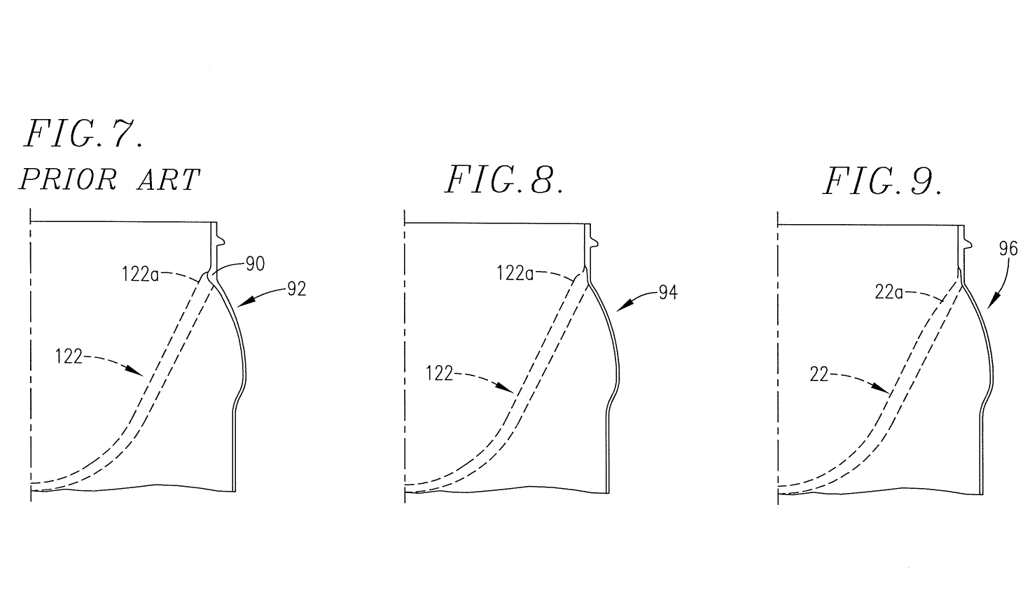

FIG. 7 illustrates the problem in the prior art, while FIGS. 8 and 9 illustrate beneficial results of applying pin-point infrared radiation to the transition region of a preform in accordance with the present invention. As illustrated in FIG. 7, conventional conditioning techniques on a preform 122 having a generally constant thickness transition region 122a have sometimes resulted in a blown bottle 90 having a bulged ring or “choke” 92 because the plastic material in the transition region 122a has failed to move and stretch properly at the blow station. Such a choke is both aesthetically displeasing and wasteful of material.

On the other hand, as illustrated in FIG. 8, when the same preform 122 is subjected to pin-point infrared radiation in the transition region 122a in accordance with the present invention, the resulting blown bottle 94 is devoid of a choke because the plastic material in the transition region 122a has been heated sufficiently as to allow the material to move and stretch to the extent necessary during the stretch and blow cycle.

Likewise, when the principles of the present invention are applied to a preform 22 having a tapering transition region 22a as illustrated in FIGS. 3 and 6, the result is a blown bottle 96 that is also devoid of a choke. An additional benefit of this preform design is the significant savings in plastic material in the transition region that otherwise serves no useful function.

In some types of injection stretch blow mold machines soft, hot preforms may be released by thread splits to some other type of carrier prior to the preforms being presented to a conditioning station. The preforms are thus supported by structure other than the thread splits during conditioning at the conditioning station. It is to be understood that the principles of the present invention may be applied with beneficial results to this type of machine as well.

The inventor(s) hereby state(s) his/their intent to rely on the Doctrine of Equivalents to determine and assess the reasonably fair scope of his/their invention as pertains to any apparatus not materially departing from but outside the literal scope of the invention as set out in the following claims.

1. In a conditioning unit for use in conditioning a hot, soft preform at the conditioning station of an injection stretch blow mold machine following formation of the preform at the injection station of the machine, the improvement comprising:
a heating chamber adapted to receive at least part of a preform below a neck portion thereof; and
an electrically powered, generally circular heater ring associated with said heating chamber in such a position and of such a size as to at least partially encircle the exterior of a preform received within the heating chamber,
said heater ring including a heating element adapted when energized to produce emissions having a wavelength in the infrared region of the light spectrum,
said heater ring being disposed for directing infrared light waves from the heating element to a transition region of the preform between the neck and main body portions thereof.

2. In a conditioning unit as claimed in claim 1,
said heating element being housed within a clear quartz tube.

3. In a conditioning unit as claimed in claim 1,
further comprising a fan disposed below said heating chamber for directing ambient air upwardly through the chamber.

4. In a conditioning unit as claimed in claim 1,
said heating chamber including an inner shield disposed to block the transmission of infrared light waves from said heating element to certain portions of the preform received within the chamber.

5. In a conditioning unit as claimed in claim 4,
said heating chamber further including an outer shield spaced radially outwardly from said inner shield,
said heater ring being disposed between said inner and outer shields.

6. In a conditioning unit as claimed in claim 5,
said inner and outer shields being generally cylindrical.

7. In a conditioning unit as claimed in claim 6,
further comprising an annular window at the top of the interior shield,
said heating element being disposed to emit infrared light waves through said window.

8. In a conditioning unit as claimed in claim 7,
further comprising a fan below said exterior and interior shields for directing cooling air upwardly between the shields and across the preform.

9. In a conditioning unit as claimed in claim 8,
further comprising a top plate that receives and engages thread splits that support the preform by its neck portion when the preform is disposed within the heating chamber,
said top plate having passages therein for the circulation of a cooling liquid through the passages.

10. In a conditioning unit as claimed in claim 1,
said preform being supported by its neck portion by thread splits while the preform is disposed within the heating chamber.

11. A method of conditioning a soft, hot preform comprising the step of exposing the transition region of the preform between the neck portion and the main body portion to infrared light waves from a heating element for a period of time.

12. A method of conditioning a preform as claimed in claim 11,
said infrared light waves being generated from an electrically energized heating element housed within a clear quartz tube.

13. A method of conditioning a preform as claimed in claim 11,
further comprising shielding other portions of the preform from infrared light waves emitted by the heating element while the transition region is exposed to the infrared light waves.

14. A method of conditioning a preform as claimed in claim 13,
further comprising directing a flow of cooling air across the preform while the preform is exposed to the infrared light waves.

15. A method of condition a preform as claimed in claim 14,
further comprising supporting the preform by thread splits while the preform is exposed to infrared waves from the heating element and cooling the thread splits while the preform is exposed to infrared waves from the heating element.

16. A method of conditioning a preform as claimed in claim 11,
further comprising directing a flow of cooling air across the preform while the preform is exposed to the infrared light waves.

17. A method of conditioning a preform as claimed in claim 11,
further comprising supporting the preform by thread splits while the preform is exposed to infrared waves from the heating element.

18. In a method of making a bottle in an injection stretch blow molding machine, the improvement comprising:
forming a preform at an injection station of the machine;
while the preform is still soft and hot, transporting the preform to a conditioning station of the machine; and
while the soft, hot preform is at the conditioning station, exposing the transition region of the preform between the neck portion and the main body portion to infrared light waves from a heating element for a period of time.

19. In a method of making a bottle as claimed in claim 18,
said infrared light waves being generated from an electrically energized heating element housed within a clear quartz tube.

20. In a method of making a bottle as claimed in claim 18,
further comprising shielding other portions of the preform from infrared light waves emitted by the heating element while the transition region is exposed to the infrared light waves.

21. In a method of making a bottle as claimed in claim 20,
further comprising directing a flow of cooling air across the preform while the preform is exposed to the infrared light waves.

22. In a method of making a bottle as claimed in claim 21,
further comprising supporting the preform by thread splits while the preform is exposed to infrared waves from the heating element and cooling the thread splits while the preform is exposed to infrared waves from the heating element.

23. In a method of making a bottle as claimed in claim 18,
further comprising directing a flow of cooling air across the preform while the preform is exposed to the infrared light waves.

24. In a method of making a bottle as claimed in claim 18,
further comprising supporting the preform by thread splits while the preform is exposed to infrared waves from the heating element.
